(19) United States
(12) Patent Application Publication
(10) Pub. No.: US 2015/0037498 A1
(43) Pub. Date: Feb. 5, 2015

(54) METHODS AND PREFORMS TO MASK HOLES AND SUPPORT OPEN-SUBSTRATE CAVITIES DURING LASER CLADDING

(71) Applicant: Siemens Energy, Inc., Orlando, FL (US)

(72) Inventors: Gerald J. Bruck, Oviedo, FL (US); Ahmed Kamel, Orlando, FL (US)

(21) Appl. No.: 14/444,108

(22) Filed: Jul. 28, 2014

Related U.S. Application Data
(63) Continuation-in-part of application No. 13/956,635, filed on Aug. 1, 2013.

(51) Int. Cl. B05D 3/02

(52) U.S. Cl. CPC B05D 3/0254; B05D 2202/00; B05D 2401/40
USPC 427/229; 428/457

(57) ABSTRACT

This invention relates to methods in which a protective material (44) is introduced into a metallic component, or is used to block a hole (48) in the metallic component, a filler material (34) is pre-placed or directed to an external surface of the metallic component, the filler material is heated with at least one energy beam (40) to melt or sinter a metal powder (36) contained in the filler material to form a cladding layer (16), and the protective material is removed from the metallic component, such that the protective material contains, or generates upon being heated, a protective substance. The present invention also relates to preforms (72) containing an upper section (74) containing a powdered metal (36) and a flux (38), and a lower section (76) containing a protective material (78), such that the protective material contains, or generates upon being heated, a protective substance.

This application is a continuation-in-part of U.S. patent application Ser. No. 13/956,635 filed on 1 Aug. 2013 (attorney docket number 2013P12505US), incorporated herein by reference.

### FIELD OF THE INVENTION

This invention relates generally to the field of metal-component fabrication and repair, and more particularly to the fabrication and repair of hollow superalloy components containing cavities and/or holes.

### BACKGROUND OF THE INVENTION

Modern gas turbines require cooling systems to protect the turbine blades, vanes, endwalls, shroud and other components from the increasingly higher metal temperatures that are demanded for improved performance. There are five basic cooling techniques employed in modern gas turbine engines: convection cooling, impingement cooling, film cooling, transpiration cooling and water/steam cooling. Several of these techniques rely in part on the placement of holes or cavities in vital engine components to facilitate fluid flow.

FIG. 1 illustrates an exemplary cross section of a hollow turbine blade airfoil 2 containing internal cavities 8 enclosed by an external superalloy substrate 4 in which cooling holes 6 are provided to allow airflow from inside the blade airfoil 2 to blanket the outer surface of the substrate 4. Such cooling holes 6 are often located in the airfoil section 2 as well as the platform and tip sections of the blades. The passage of air through and over the blade or vane extracts heat from the component surface, which allows the component to operate even when the gas stream temperature exceeds the melting temperature of the component alloy.

During repair of engine blades and other air-cooled components it is critical to maintain the cooling holes in an unobstructed condition, and it is essential to keep the size and shape of the holes within design limits in order to achieve optimal performance of these components during engine operation. However, maintaining the cooling holes free of obstructions and within design limits of size and shape is especially difficult when performing repairs of components fabricated using superalloy materials, which are often employed in modern gas turbine components subject to increasingly higher temperatures.

Superalloy materials are among the most difficult to fabricate and repair due to their susceptibility of melt solidification cracking and strain age cracking. The term “superalloy” is used herein as it is commonly used in the art—a highly corrosion and oxidation resistant alloy with excellent mechanical strength and resistance to creep at high temperatures. Superalloys typically include high nickel or cobalt content. Examples of superalloys include alloys sold under the trademarks and brand names such as Hastelloy, Inconel alloys (e.g., IN 738, IN 792, IN 939), Rene alloys (e.g., Rene N5, Rene 80, Rene 142), Haynes alloys, and CMSX (e.g., CMSX-4) single crystal alloys to name a few.

Hollow superalloy components are often repaired using laser powder deposition processes to melt a thin layer of alloy powder particles onto an alloy substrate to form a cladding layer. Performing these techniques over holes or cavities present on an outer surface of the alloy substrate, however, can jeopardize the mechanical integrity of both the alloy substrate and the cladding layer.

FIG. 2 illustrates several problems associated with the weld repair of hollow superalloy components containing holes or cavities. In this illustration, a cladding layer 16 was applied to the outer surface of a superalloy substrate 12 by using laser powder deposition to melt alloy particles applied to the surface of the superalloy substrate 12. This process is complicated by the presence of a cooling hole 10 situated to supply cooling air from the internal cavity 14 to the outer surface of the component during operation.

The physical discontinuity at the cooling hole 10 allows molten metal to run into the cooling hole 10 causing a depression 20 in the surface of the cladding 16 below the desired cladding surface line 18. Furthermore, because the hole imparts a thermal discontinuity during the laser melting process, over-penetration (i.e., excess melting) can lead to cracking 22 in the superalloy substrate 12. Because the hole 10 provides no backing or support, the molten metal is also exposed to air within the hole 10 such that oxidation and nitridation can result in “sugaring” 24 on the lower surface of the cladding 16, as well as porosity and inclusions 26 within the cladding layer 16. Additionally, the lack of shielding in the hole 10 prevents adequate wetting of the molten metal to the superalloy substrate 16—leading to notches 28 located at the upper edges of the cooling hole 10 which increase stress in the resulting component.

Various strategies have been employed to prevent these problems by masking or plugging cooling holes and other cavities prior to performing repair welding or brazing. Masking using wires or weld metal can be effective in plugging cooling holes, but such material must be removed afterwards using time-consuming and expensive techniques. Furthermore, debris from such removal is difficult to control and can cause blockages and other issues in other parts of the component. Masking using evaporative materials such as wax, polymer, epoxy, etc. is also known, but these materials may prematurely dissipate and fail to adequately protect the component. Also, use of such foreign material can contaminate the deposited cladding layer leading to defects such as porosity, cracks and inclusions. Ceramic materials can also be used to plug cooling holes, but these approaches require either tedious installation of pre-formed ceramic inserts or elaborate processing steps to form a ceramic plug or mask within the hole or cavity.

There is a need to develop simple and inexpensive methods and materials to mask and protect cooling holes which allow for the repair and manufacture of hollow superalloy components free from the defects described above. A similar need also exists to develop methods and materials to fabricate metallic (superalloy) layers over open cavities without imparting the defects described above.

### BRIEF DESCRIPTION OF THE DRAWINGS

The invention is explained in the following description in view of the drawings that show:

FIG. 1 illustrates an exemplary cross section of a prior art hollow turbine blade airfoil.

FIG. 2 illustrates several prior art problems associated with the weld repair of hollow superalloy components containing holes or cavities.

FIG. 3 illustrates a laser powder deposition and melting process employing a protective material to create a superalloy cladding layer over a cooling hole or cavity.

FIG. 4 illustrates a defect-free superalloy structure resulting from the laser powder deposition and melting process of FIG. 3.

FIG. 5 illustrates a laser powder deposition and melting process employing a protective material to create a shaped cladding layer over a hole or open cavity.

FIG. 6 illustrates the use of a multi-layer preform including a lower compartment containing a protective material.

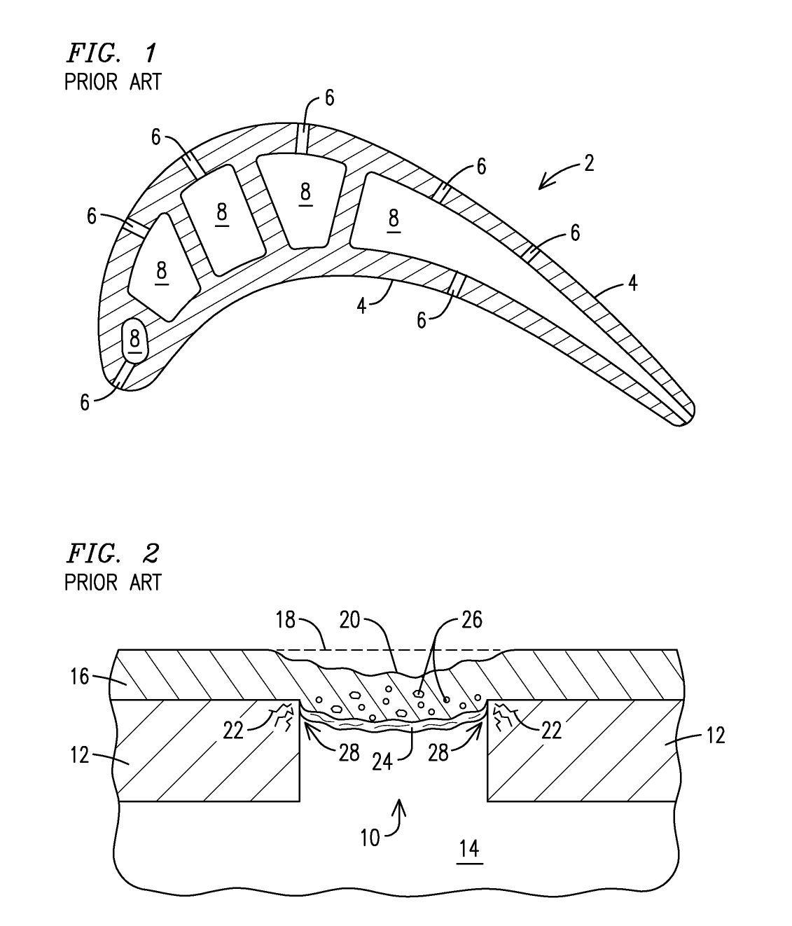

### DETAILED DESCRIPTION OF THE INVENTION

The present inventors have discovered novel methods and materials for forming metallic cladding layers over open cavities and holes located in metallic components. In these disclosures, a protective material is employed which can function as a supportive structure (reducing or preventing a molten metal from entering the open space), a barrier structure (preventing a molten metal from entering the open space and optionally defining the shape of the resulting cladding layer), and as a protective agent (reducing or preventing chemical and/or mechanical imperfections in the resulting cladding layer). Such protective support or blocking materials may exist as individual (standalone) structures, or beds of material, or as multi-layered preform structures constructed of metallic filler-containing compartments and at least one protective supporting compartment. The use of multi-layered preform structures enables the additive manufacture and repair of relatively large, hollow superalloy components containing intricate structural features with a high degree of structural precision and with a minimal amount of chemical/mechanical imperfections.

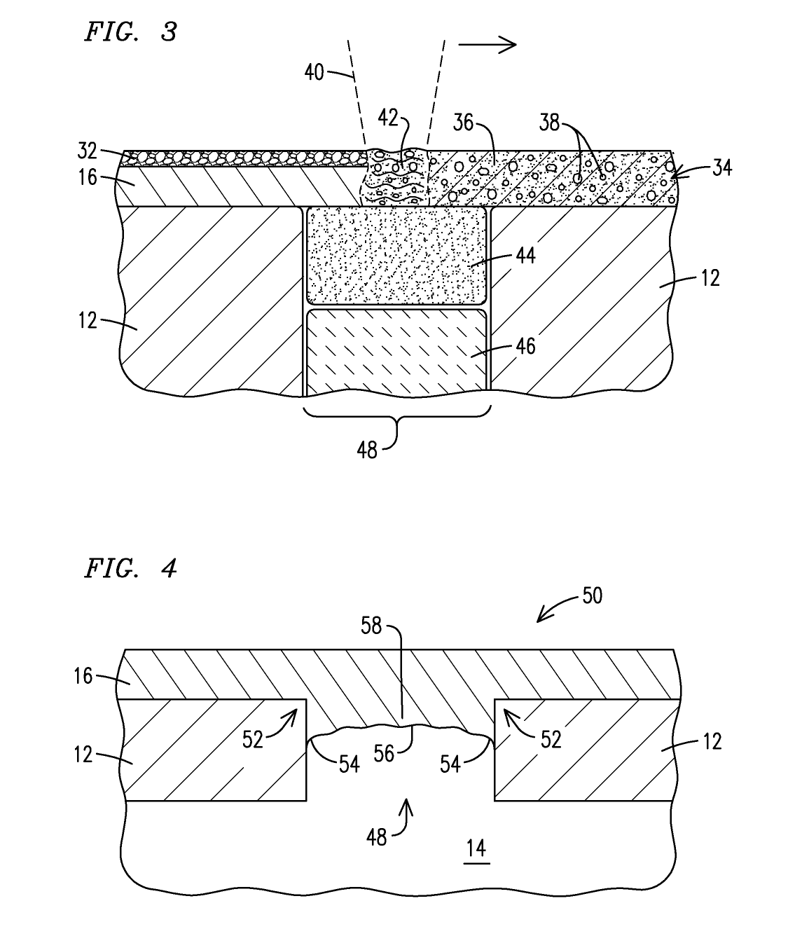

FIG. 3 illustrates one embodiment wherein a protective material 44 is introduced into a cooling hole 48 which penetrates a superalloy substrate 12 portion of a hollow component. In this example a filler material 34 is then applied to the upper surface of the superalloy substrate 12 such that the filler material 34 is at least partially supported by the protective material 44. The filler material 34 may contain a mixture of a metal powder 36 and a powdered flux material 38. In this non-limiting example an energy beam 40 (such as a laser beam) is then traversed across the surface of the filler material 34 (shown moving from left to right in FIG. 3), such that heat imparted by the energy beam melts the filler material 34 to generate a melt pool 42 at least partially supported by the protective material 44. The melt pool 42 is then allowed to cool and solidify to form a cladding layer 16 and optionally a slag layer 32.

Although the illustration in FIG. 3 employs a filler material 34 containing a mixture of the metal powder 36 and the powdered flux material 38, in other embodiments the metal powder 36 and the powdered flux material 38 may exists in separate layers of the filler material 34. For example, the powdered flux material 38 may exists as a separate layer disposed on top of a separate layer containing the metal powder 36. In still other examples the metal powder 36 and the flux material 38 may be contained in a multi-container preform that is supported by a separate protective material 44, or which includes the protective material 44 within a separate container of the same preform. The metal and flux materials may also be introduced as conglomerate/composite particles containing both constituents. In other non-limiting examples the filler material 34 may not contain a flux material 38. When a flux material is present in the filler material 34, a resulting slag layer 32 may be later removed by physical or chemical methods known in the art.

In some embodiments the protective material 44 provides necessary support without the aid of an underlying support structure. For example, some protective materials 44 can be shaped to tightly compliment the interior surface of the hole or cavity. In other examples the protective material 44 is in a moldable form which conforms to the interior surface of the hole or cavity. In still other embodiments the protective material 44 is a multi-layered or multi-sectioned protective material capable of providing necessary support through friction, preloading or complementarity.

In other embodiments the protective material 44 is itself supported by a fugitive support material 46. “Fugitive” means removable after formation of the cladding layer, for example, by direct (physical removal), by a mechanical process, by draining, by fluid flushing, by chemical leaching and/or by any other known process capable of removing the fugitive support material 46 from its position. Examples of fugitive support materials 46 include powders (e.g., metal, glass, ceramic, fiber powders), solid objects (e.g., metal, glass, ceramic, composite, plastic, resinous structures, graphite, dry ice), woolen materials (e.g., steel wool, aluminum oxide wool, zirconia wool) and foamed materials (e.g., polymer foams, high-temperature spray foams) to name a few. Any material or structure capable of providing support and then being removable after the formation of the cladding layer 16 may serve as the fugitive support material 46.

In still other embodiments the protective material 44 acts as an underlying support structure. For example the protective material 44 can fill the entire space of the hole or cavity. As an illustration of such an embodiment, the protective material 44 may be in the form of a powder which fills the entire (or nearly the entire) space of the hole or cavity. Such a protective material 44 in powdered form may then be removed from the metallic component after formation of the cladding layer 16.

In the region of the cooling hole 48, the protective material 44 performs three functions. First, it supports the melt pool 42 to reduce or prevent molten metal from migrating into the cooling hole 48. Second, it acts as a thermal sink or insulator to reduce or minimize thermal discontinuity in the region of the cooling hole and optionally to provide an ability to control the grain size and structure of cladding particles deposited over the cooling hole 48. Third, it protects the cladding layer 16 and the superalloy substrate 12 by generating a protective substance which is capable of performing at least one protective function.

The protective material 44 often contains at least one inorganic material and can be in the form of a powder, a moldable paste or putty, a single-layer or multi-layer sheet, a ceramic, a composite material, a textile, a woolen material, or other forms capable of supporting the melt pool and possessing the necessary (high-temperature) thermal characteristics.

The method of fabricating and/or installing the protective material 44 largely depends upon its form. Non-limiting examples include: (i) introducing a free powder (or mixture of powders) into the cavity or hole using gravity or with the aid of an applicator or a compressed gas or a vacuum; (ii) introducing a powder or composite material contained in a rigid or moldable container fabricated of a metallic material (e.g., a metallic mesh, net or foil) or an organic material (e.g., paper, plastic, resin) or inorganic material (e.g. silica, alumina, zirconia); (iii) introducing a pre-formed ceramic in powder or solid form (optionally within a container as described above) or formation of a ceramic within the hole or cavity through methods known in the relevant art; (iv) introducing a putty or paste into a hole or cavity by physical means (e.g., by physical applicator (e.g., spatula) or under pressure) from the outside or inside of the metallic component; (v) placement of a compressed sheet into a hole or cavity, in which the compressed sheet is either complimentary to the interior surface of the component or is supported by a fugitive support material; (vi) introducing a woolen material into the hole or void (from the outside or inside of the metallic component) with or without a fugitive support material acting as an underlying support, and by other methods known to those skilled in the relevant art.

The term “inorganic material” includes metals, alloys, inorganic oxides, inorganic salts and other inorganic materials and combinations thereof capable of imparting a rigid, supportive form to the protective material 44 under high-temperature conditions (e.g., at or above the melting temperature of a nickel-based superalloy (˜1350° C.)). Inorganic materials can include powdered metals, metal oxides, metal carbonates, metal halides, metal silicates, metal borates, metal fluorides, or mixtures thereof. In some embodiments the inorganic material contains at least one metal oxide selected from a magnesium oxide, a manganese oxide, an aluminum oxide, a silicon oxide, a calcium oxide, a titanium oxide, a yttrium oxide, a zirconium oxide, a hafnium oxide, a cerium oxide, and mixtures thereof. For example, in some embodiments the inorganic material may contain a mixture of metal oxides such as a zirconium oxide, a silicon oxide and a titanium oxide—such that a melting point of the inorganic material exceeds 2000° C. In other instances the inorganic material may be a powdered metal oxide such as zirconium oxide.

The contents of the protective material 44 may be selected to control the magnitude and direction of local heat conduction and the solidification rate and, thus, the solid internal structure of the cladding layer 16 in the vicinity of the hole or cavity. A higher thermal conductivity material will tend to transfer heat out of the melt pool 42 more rapidly. A lower thermal conductivity material will tend to transfer heat out of the melt pool 42 more slowly. A material matching the thermal conductivity of the adjoining component will produce heat management such that the hole is not a thermal discontinuity for the process. Using this approach it is possible to control the grain size, orientation and structure as well, e.g., to promote formation of equiaxed or columnar or even single crystal grain structures.

The size and texture of particles optionally contained in the protective material 44 may also be controlled to affect the mobility of a molten metal into the hole or cavity. For example, when using a powdered inorganic material the size of the powder particles may be set to be smaller than the size of the particles in the filler material 34. In some embodiments, for instance, the particle size of a powdered protective material 44 is set to be at least one-half of the size of the metal powder 36 in the filler material 34 (see FIG. 3).

To accomplish its protective function the protective material 44 contains, or generates upon being heated, a protective substance which provides at least one protective feature.

In some cases the protective substance functions as a barrier shield or blanket to separate one or both of the molten metal and the metallic substrate from the atmosphere, in order to minimize or eliminate oxidation and nitridation of the metallic substrate 12 and/or the resulting cladding layer 16. One non-limiting example of an organic shielding material is cellulose which breaks down into CO, CO₂ and H₂ that can be effective for shielding. In some cases the protective substance functions as a reducing agent that prevents the formation of (or removes) oxides on the surface (or interior) of the metallic substrate 12 and/or the cladding layer 16. The use of a barrier shield, a reducing agent, or both, can eliminate the necessity of using expensive inert gases or low pressure (vacuum) conditions, and can also reduce or eliminate the occurrence of sugaring 24 on the surface of cladding layer 16 as well as porosity and inclusions 26 (see FIG. 2).

In some cases the protective substance functions as a thermal shield or blanket allowing the molten metal and the metallic substrate to cool slowly and evenly, thereby reducing residual stresses that can contribute to post-weld reheat-cracking or strain-age cracking. The use of a thermal shield/blanket can also reduce or eliminate the occurrence of cracks 22 in both the metallic substrate 16 and the cladding layer 16 (see FIG. 2).

In some cases the protective substance functions as a wetting agent which improves contact between the molten metal and the metal substrate through various mechanisms such as reducing viscosity of the molten metal and removing oxides from the surface of the metal substrate. The use of a wetting agent can reduce or eliminate the occurrence of notches 28 at the interface of the cladding layer 16 with the metallic substrate 12 (see FIG. 2).

In some cases the protective substance functions as a cleanser or absorption agent which can remove trace impurities, such as sulfur and phosphorous, and can also remove unwanted metal oxides. The use of a cleanser or absorption agent can reduce or eliminate the occurrence of post-solidification cracking 22 of the cladding layer 16 and/or the metal substrate 12, and can also reduce or eliminate the occurrence of sugaring 24 as well as porosity and includes 26 in and on the cladding layer 16 (see FIG. 2).

In some embodiments the protective material simultaneously provides one or more of the protective functions described above—either through the action of a single protective substance or through the action of a mixture of different protective substances.

The protective material 44 either includes the protective substance as an initial component or generates the protective substance upon heating (which occurs due to melting of the filler material 34 with the energy beam 40). For embodiments wherein the protective substance is generated by heating, the protective substance is formed as a liquid or as a gas or as a compound that is removed by way of slag formation. The formation process may occur by a phase-transition process (e.g., melting, evaporation, or sublimation) or by a reaction process (e.g., thermal decomposition or reaction with another substance). Reaction processes leading to the formation of a protective substance may include, for example, reactions with water (e.g., Y+H₂O→Y(OH)₂+H₂), reactions with acids (e.g., CaF₂+HCl→CaCl₂+HF), and thermally-induced decompositions (e.g., CuCO₃→CuO+CO₂).

In some embodiments an inorganic material may act as the protective substance or may undergo a phase change or reaction to from the protective substance. In other embodiments the protective material 44 contains both an inorganic material and at least one additional component that either acts as the protective substance or undergoes a phase change or reaction to form the protective substance.

Compounds acting as, or forming, protective substances include both organic and inorganic compounds.

Examples of organic compounds directly or indirectly fulfilling the protective function of the protective material 44 include high-molecular weight hydrocarbons (e.g., beeswax, paraffin), carbohydrates (e.g., cellulose), natural and synthetic oils (e.g., palm oil), organic reducing agents (e.g., charcoal, coke), carboxylic acids and dicarboxylic acids (e.g., abietic acid, isopimaric acid, neoabietic acid, dehydroabietic acid, rosins), carboxylic acid salts (e.g., rosin salts), carboxylic acid derivatives (e.g., dehydroabietylamine), amines (e.g., triethanolamine), alcohols (e.g., high polyglycols, glycerols), natural and synthetic resins (e.g., polyol esters of fatty acids), mixtures of such compounds, and other organic compounds capable of fulfilling the protective functions described above.

Examples of inorganic compounds directly or indirectly fulfilling the protective function of the protective material 44 include reactive metals (e.g., iron ore), metal oxides (e.g., magnesium oxide, manganese oxide, aluminum oxide, silicon dioxide, calcium oxide, titanium oxide, yttrium oxide, zirconium oxide, hafnium oxide, copper oxide, cerium oxide), metal halides (e.g., lithium chloride, zinc chloride, barium chloride, magnesium chloride, tin chloride, calcium fluoride), halide salts (e.g., ammonium chloride), borates (e.g., borax), metal fluoroborates (e.g., potassium fluoroborate), metal sulfides (e.g., lead sulfide), metal carbonates (e.g., calcium carbonate, sodium carbonate, sodium bicarbonate, potassium carbonate), metal aluminates (e.g., cryolite), mineral acids (e.g., hydrochloric acid, hydrobromic acid, phosphoric acid), metal silicates (e.g., sodium silicate), mixtures of such compounds, and other inorganic compounds capable of fulfilling the protective functions described above.

In some embodiments the protective substance is provided by a commercially available flux material. Examples of known flux materials capable of fulfilling at least one protective function include Lincolnweld P2007, Bohler Soudokay NiCrW-412, ESAB OK 10.16 or 10.90, Special Metals NT100, Oerlikon OP76, Sandvik 50SW or SAS1 or specialized fluxes that are specifically formulated for laser (versus arc) processing (i.e., without the need for arc stabilizers) and are known in the relevant art. In some instances the inorganic material of the protective material 44 is a commercially available flux material. In other instances the protective material 44 contains both an inorganic material (e.g., zirconium oxide) and a commercially available flux material. The flux particles may be ground to a desired smaller mesh size range before use.

Use of a protective material 44 satisfying the requirements described above not only prevents or minimizes intrusion of the molten metal (i.e., the melt pool 42) into the cooling hole 48 (see FIG. 3), but also reduces or eliminates to occurrence of chemical and mechanical imperfections in the resulting metallic structure. FIG. 4 illustrates a defect-free superalloy structure resulting from an exemplary selective laser melting process performed as described above and depicted in FIG. 3. Unlike the depression 20 which is present in the cladding layer 16 of FIG. 3, the surface of the cladding layer 16 in FIG. 4 does not deviate significantly from the cladding surface line 18 (see FIG. 2). Furthermore, the cladding interface with the superalloy substrate 12 is in the form of a notch-free weld toe 54 (see also FIG. 3) without a disadvantageous notched weld toe 28 (as observed in FIG. 2). Both the substrate 12 and the cladding layer 16 are free of cracks 52, and the cladding layer 16 shows no evidence of sugaring 24 on its lower surface 56 and no evidence of pores or inclusions 26 within the cladding layer 58.

After performing laser powder deposition (e.g., laser cladding, selective laser melting or sintering, etc.) to produce the cladding layer 16, the protective material 44 may be removed using a number of techniques depending upon the form of the protective material 44. Non-limiting examples include: (i) removing a remaining powder through the hollow interior of the metallic component using physical agitation with or without the aid of a gas flow; (ii) laser drilling an access hole through the cladding layer (into the cooling hole) and physically removing the remnants of the protective material 44 either through the hole or through the hollow interior; (iii) chemically removing the remnants of a ceramic protective material 44 using a leaching agent (e.g., a potassium hydroxide solution); (iv) physically removing the remnants of a sheet-like protective material 44 by using a chemical leaching agent or by using a physical method (e.g., ultrasound) to break up the remnants; (v) dissolving a spray foam fugitive support material 46 allowing the remnants of a sheet-like protective material 44 to be readily removed from the interior of the hollow metallic component, and by other methods known to those skilled in the relevant art.

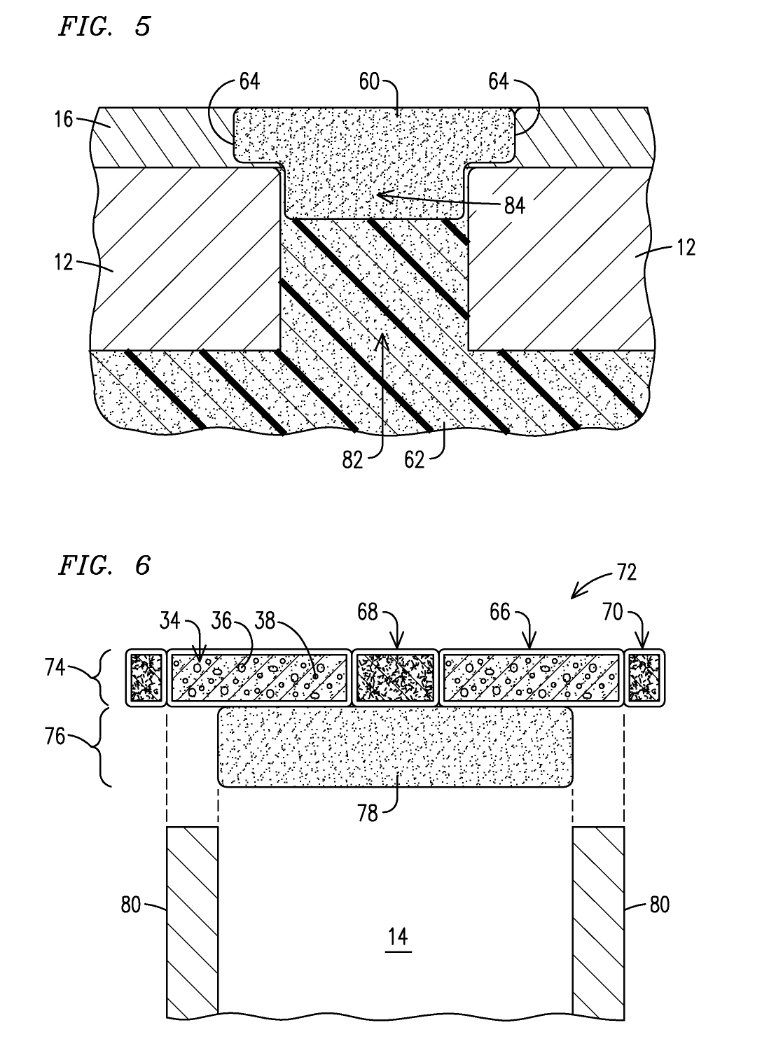

FIG. 5 depicts another embodiment wherein a protective material 60 is placed over a hole or open cavity 82 within a superalloy substrate 12 of a metallic component. During a subsequent melting process to deposit a cladding layer 16 onto a surface of the superalloy substrate 12 covering the hole or open cavity 82, the protective material 60 performs four functions. First, it prevents the molten metal from migrating into the hole or open cavity 82. Second, it acts as a mold or template to impart a defined shape 64 to the boundary of the cladding layer 16 surrounding the hole or open cavity 82. Third, it acts as a thermal sink or insulator to reduce or minimize thermal discontinuity in the region of the hole or cavity 82 and optionally provides an ability to control the grain size and structure of the cladding grain particles as described above. Fourth, it protects the cladding layer 16 and the superalloy substrate 12 by generating a protective substance which is capable of performing at least one protective function as described above.

The protective material 60 may contain the same materials described above for the protective supporting material 44. The protective material 60 may also be in the form of a powder, a moldable paste or putty, a single-layer or multi-layer sheet, a ceramic, a composite material, a textile, a woolen material, or other forms capable of (fully or partially) withstanding contact with a molten metal and shaping the melt pool into a defined shape 64.

The protective material 60 may also contain a lower protrusion 84 capable of providing a registration function allowing easier placement and improved adherence to the surface of the substrate 12. In some embodiments wherein the diameter of the protective material 60 is not sufficient to provide adequate support over the hole or open cavity 82, a fugitive support material 62 may be employed to support the protective material 60. In the non-limited example depicted in FIG. 5, the fugitive support material is a spray foam 62. The protective material 60 could also be supported by other fugitive support materials as described above.

FIG. 6 depicts the cross-sectional view of another embodiment wherein a protective material 78 is contained within a multi-layered preform 72 useful in an additive manufacturing process of a turbine fan blade tip. The preform 72 contains an upper compartment 74 and a lower compartment 76. These compartments are joined together to form the preform 72 which can be readily handled and placed over the empty space 14 in the hollow section between the walls 80 of a turbine blade airfoil. In some embodiments the walls 80 are manufactured in an iterative (step-wise) fashion by an additive manufacturing process.

In the non-limiting exemplary embodiment of FIG. 6 the upper compartment 74 contains a doughnut-shaped or annular (circular or non-circular) filler compartment 66, a central blocking compartment 68, and a surrounding ring-shaped peripheral blocking compartment 70. In this example the filler compartment 66 contains a filler material 34 containing a metal powder 36 and a powdered flux material 38. The central and peripheral blocking compartments 68, 70 contain a non-metallic energy beam blocking material such a graphite or zirconia which provides an energy absorbing material for defining either boundary lines or holes within a cladding layer formed by a laser melting process. The peripheral blocking compartment 70, for instance, may be used to form a laser scan line surrounding a resulting cladding tip of the airfoil. The central blocking compartment 68, for instance, may be used to form a central cooling hole.

The lower compartment in the embodiment of FIG. 6 contains a protective material 78 as described above. The protective material 78 can perform the supportive and protective functions described above with or without an underlying fugitive support material. The protective material 78 can also provide a registration function allowing easier placement and improved adherence to the inside surfaces of the blade walls 80.

In some embodiments the preform 72 may contain additional compartments (on the either or both of the upper and the lower compartments 74, 76) to account for additional physical structures to be fabricated in an additive manufacturing process. In some embodiments the protective material 78 may be separate from the preform, such that the preform only contains a single level including, for example, a filler compartment 66 and a central and/or peripheral blocking compartment 68, 70. In some embodiments the upper compartment 74 or the lower compartment 76 may themselves be multi-layered compartments containing different materials. In one non-limiting example the lower compartment 76 contains both a protective material 78 and a lower fugitive support material. In another non-limiting example the lower compartment 76 contains a commercial flux material in an upper level and the protective material 78 in a lower level.

As will be realized, the present invention is capable of other and different embodiments, and its several details are capable of modifications in various obvious respects, all without departing from the present invention. In this regard, the description herein is to be understood as illustrative in nature, and not as restrictive. Accordingly, it is intended that the invention be limited only by the spirit and scope of the appended claims.

The invention claimed is:

1. A method, comprising:
introducing a protective material into an opening in a metallic component, such that a filler material pre-placed or directed to an external surface of the metallic component is supported by the protective material;
heating the filler material with at least one energy beam to melt a metal powder contained in the filler material, thereby forming a melt pool supported by the protective material;
allowing the melt pool to cool and solidify to form a metal layer fused to the external surface; and
removing the protective material from the metallic component,
wherein the protective material contains, or generates upon being heated during the heating of the filler material, a protective substance.

2. The method of claim 1, wherein the protective material comprises a flux material.

3. The method of claim 1, wherein the protective material comprises at least one of:
an inorganic compound selected from the group consisting of a metal oxide, a metal carbonate, a metal halide, a metal silicate, a metal borate, a metal fluoride, a metal fluoroborate, and mixtures thereof, and
an organic compound selected from the group consisting of a carbohydrate, an organic reducing agent, an carboxylic acid, a dicarboxylic acid, a carboxylic acid derivative, an amine, an alcohol, a natural resin, a synthetic resin, and mixtures thereof.

4. The method of claim 1, wherein the protective material comprises an inorganic oxide and a flux material.

5. The method of claim 1, wherein the protective support material comprises at least one inorganic oxide selected from the group consisting of a magnesium oxide, an aluminum oxide, a silicon dioxide, a calcium oxide, a titanium oxide, a yttrium oxide, a zirconium oxide, a hafnium oxide, and a cerium oxide.

6. The method of claim 1, wherein the protective material comprises zirconia or graphite.

7. The method of claim 1, wherein the protective material is in the form of a powder, a paste, a putty, a sheet, a ceramic, a composite material, an inorganic textile, or a woolen material.

8. The method of claim 1, wherein the metallic component is made of a superalloy material, and the metal powder comprises constituents of the superalloy material.

9. The method of claim 1, wherein the protective material is in the form of a compressed sheet comprising zirconia or graphite.

10. The method of claim 1, wherein the filler material further comprises a powdered flux material which is mixed with the metal powder.

11. The method of claim 1, wherein the filler material comprises:
a first filler layer comprising the metal powder disposed on an upper surface of the protective material; and
a second filler layer comprising a powdered flux material disposed above the first filler layer.

12. The method of claim 1, further comprising:
introducing a fugitive support material into the opening, such that the fugitive support material supports the protective material; and
removing the fugitive support material from the metallic component after formation of the metal layer.

13. The method of claim 1, wherein the filler material is contained within a preform partitioned into a plurality of compartments including at least one compartment containing the metal powder, such that the metal powder is constrained in a distribution that imparts a desired shape to the metal layer in response to the melting of the metal powder with the energy beam.

14. The method of claim 13, wherein the preform comprises:
a filler compartment containing the metal powder and a powdered flux material; and
a laser blocking compartment containing a non-metallic laser blocking material.

15. The method of claim 1, wherein:
the protective material and the filler material are contained within a preform partitioned into a plurality of compartments comprising:
(i) a upper compartment containing the metal powder and a powdered flux material; and
(ii) a lower compartment containing the protective material;
the metal powder is constrained in the upper compartment in a distribution that imparts a desired shape to the metal layer in response to melting of the upper compartment with the energy beam; and
the lower compartment has a shape which is complementary to an inside surface of the metallic component.

16. The method of claim 15, wherein the upper compartment comprises:
a filler compartment containing the metal powder and the powdered flux material; and
a laser blocking compartment containing a non-metallic energy beam blocking material.

17. A method, comprising blocking a hole contained in a metallic substrate with a protective material, and then melting or sintering a powdered material disposed on a surface of the metallic substrate in contact with the protective material, to form a cladding layer in which the protective material at least in part defines a shape of cladding layer adjacent to the hole, wherein:
the powdered material comprises a metallic material, a ceramic material, or both; and
the protective material contains, or generates upon being heated, a protective substance.

18. The method of claim 17, wherein the protective material comprises at least one of:
an inorganic compound selected from the group consisting of a metal oxide, a metal carbonate, a metal halide, a metal silicate, a metal borate, a metal fluoride, a metal fluoroborate, and mixtures thereof; and
an organic compound selected from the group consisting of a carbohydrate, an organic reducing agent, an carboxylic acid, a dicarboxylic acid, a carboxylic acid derivative, an amine, an alcohol, a natural resin, a synthetic resin, and mixtures thereof.

19. The method of claim 17, wherein the protective material is in the form of a powder, a paste, a putty, a sheet, a ceramic, a composite material, an inorganic textile, or a woolen material.

20. A preform for supporting and fabricating a layer of a component by additive manufacturing, the preform comprising:
(i) an upper section comprising a powdered metal and a flux; and
(ii) a lower section comprising a protective material comprising an inorganic substance, wherein:
the powdered metal is constrained in the upper section in a distribution that creates a metal layer having a desired shape in response to melting of the upper section with an energy beam; and
the protective material contains, or generates upon being heated during the melting of the upper section, a protective substance.
